(19) United States
(12) Patent Application Publication
(10) Pub. No.: US 2010/0095534 A1
(43) Pub. Date: Apr. 22, 2010

(54) Cutting Tool Adapter for Rotary Power Tools

(76) Inventor: Albert Saiz, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/648,291

(22) Filed: Dec. 28, 2009

Related U.S. Application Data
(63) Continuation-in-part of application No. 11/636,729, filed on Dec. 11, 2006.
Application No. 11/636,729 is a continuation-in-part of application No. 11/448,358, filed on Jun. 7, 2006, now abandoned.

(51) Int. Cl. B26B 27/00; B25F 3/00

(52) U.S. Cl. 30/272.1; 279/144; 408/239 A

(57) ABSTRACT

A cutting tool adapter that, in the preferred embodiment, removably attaches to a rotary power tool, such as die grinder or the like, to convert the rotary power tool into a cutting tool for cutting asphalt composition shingles, linoleum flooring, carpet, drywall and other work materials. In a preferred embodiment, the cutting tool adapter comprises an adapter body, a blade support integral with the adapter body, a cutting blade removably attached to the blade support and a vibrating mechanism disposed inside a chamber of the adapter body and rotatably connected to a rotating assembly of the power tool to rotate therewith and vibrate the cutting blade. In a preferred embodiment, the vibrating mechanism comprises an elongated shaft having one or more eccentric weights attached thereto and disposed above the cutting blade. One or more bearings attached to the shaft can be used to rotatably support the shaft inside the chamber.

### CROSS-REFERENCE TO RELATED APPLICATIONS

This patent application claims the benefit of U.S. patent application Ser. No. 11/636,729 filed Dec. 11, 2006, which is continuation-in-part of U.S. patent application Ser. No. 11/448,358 filed Jun. 7, 2006.

### BACKGROUND OF THE INVENTION

A. Field of the Invention

The field of the present invention relates generally to tools utilized for cutting work materials, including composition roof shingles, linoleum flooring, carpet, drywall and the like. More particularly, the present invention relates to such cutting tools that are specifically configured to vibrate the cutting blade to improve the cutting operation of the tool. Even more specifically, the present invention relates to a blade supporting adapter that attaches to a rotary power tool to cut the work material.

B. Background

Various roofing materials are utilized as the outer, environmental barrier on roofs throughout the world. The most common type of roofing material utilized in the United States and Canada are asphalt-based shingles, which are commonly referred to as composition roofing shingles or composition shingles due to the combination of materials used for the shingles. The most common types of composition shingles comprise a tough reinforcing membrane or fabric, which is typically either a fiberglass-based mat or an organic felt, that is covered or impregnated with one or more layers of asphalt and/or asphalt mixtures. In some areas of the country, particularly those in hot and humid areas, zinc or copper granules are applied to the fiberglass mat or organic felt to protect against the growth of algae. Modified asphalt composition shingles utilize a rubber modifier, such as Styrene or Polypropylene based material, to enhance flexibility, durability, crack resistance, impact resistance and resistance to ultraviolet light. Historically, the most common type of a composition shingle has been the three-tab shingle. A more modern type of shingle, commonly referenced as architectural laminated shingles, is an asphalt composition shingle having a textured look designed to simulate wood, concrete or slate in order to provide a much less expensive alternative to the “real” material. Composition shingles were originally sold as having a 15 year life. Today, most composition shingles are marketed as having a minimum of a 20 year life, with some manufactures offering composition shingles having a 30 to 50 year estimated life, such as those sold under the Grand Sequoia® and Presidential® brands. One of the primary differences between the lower and longer life shingles is the thickness of the shingles, particularly with regard to the longest life shingles, which can have three layers of shingles combined together into one shingle.

During the installation of a roof having composition shingles it is necessary to cut the shingles to the size and shape necessary for the layout of the roof. The typical cutting tool for composition shingles is a hand-held utility knife, usually of the type having a retractable blade that extends from or retracts into the knife handle. Over the years, the knife utilized by roofers has evolved from the common straight edged blade utility knife to one having a hooked or notched shaped blade portion to better get under and cut through composition shingles. These specialty utility knives are commonly referred to as composition or roofers knives. One common configuration for composition knives utilizes a carbon hook utility blade having a pair of facing hook portions separated by a center mounting hole that allows the user to swap ends of the blade when one of the hook portions becomes dull due to use. Another common configuration is referred to as a bow-tie roofer blade, which has a pair of generally V-notched cutting sections at each end separated by the center mounting hole. Although they require manual application of sufficient force to cut through the composition shingles, both types of knives have worked generally well for many years. The main problem with composition knives is that the asphalt material in the composition shingles tends to bunch or clog up around the blade's hook or notch section, thereby making further cutting difficult. With the advent of the thicker, longer life composition shingles (i.e., those having an estimated useful life of 30 or more years), it has become even more difficult to cut the shingles with the standard, hand-held composition knife.

Over the years, various people have developed improved shingle cutting tools for cutting composition shingles. For instance, U.S. Pat. No. 2,914,851 to Rogers describes a shingle cutter that is configured as a pistol-grip type of device that has cutter blade which pivots between a pair of horizontal legs to cut a shingle when the user squeezes the grip member towards the handle. U.S. Pat. No. 4,821,609 to Rushbrook describes a shingle cutting tool having a cutting body, made from a flat plate made from hardened steel, that is attached to an elongated handle. The cutting body has a pair of opposite directed V-shaped notches having sharpened cutting edges. The notches face in opposite directions to allow the user to push or pull the tool across the shingles to cut them. U.S. Publication No. 2004/0128836 to Garrett describes a shingle cutting tool that is alternatively shown as a miniaturized reciprocating saw, a miniaturized circulating saw and a standard hook-configured composition knife adapted to receive compressed air to move the blade in a reciprocating motion. Although the reciprocating motion of the composition knife version of the Garrett reference appears to reduce the need for the user to pull the knife through the composition shingle, in reality the tool would likely have the same problem with regard to the asphalt material clogging the hook portion of the blade while the user attempts to pull or push the blade through the shingles. U.S. Publication No. 2005/0204652 to Schafer describes a shingle cutting device having one or more hooked cutting blades which are attached to a base section with a C-shaped channel that is configured to fit over and slidably engage an upwardly extending ridge on a roof to cut the section of the shingles in a roof valley.

Cutting knifes are also utilized to cut carpet, drywall and other work materials. Generally, these knifes are provided with cutting blades that are, at least to certain degree, specially configured to beneficially cut a specific type of work material and to attach to a specifically configured handle. The configuration of the blades and knife handles have evolved based on preferences of the users and the attributes of the materials to be cut. Other than the shape of the blade and/or the handle, these knifes generally function the same way they have for many years. Improvements to the cutting knifes for carpet, drywall and other work materials have been similar to that described above for knifes configured to cut composition shingles and the like, generally incorporating reciprocating knife blades or rotating knife blades. It has generally been perceived by those skilled in the art that the reciprocating and/or rotating motion of a cutting blade is easier to cut with than a stationary blade.

One of the most common types of tools utilized by both professionals and homeowners are rotary power tools, which include such power tools as drills, the Dremel and RotoZip rotary power tools (which are both manufactured by the Robert Bosch Tool Corporation) and die grinders. As well known in the art, these and other power tools have a rotating element, typically a chuck, collet and/or other clamping mechanism, that clamps onto and rotates a drill bit, burr or other tool component to perform a work operation, such as drilling, grinding, sharpening, cutting, cleaning, sanding, routing, carving and engraving. The rotating element of the power tool rotates the tool component such that when the tool component is placed in direct contact with the work material it accomplishes the desired work operation. The rotating element of the power tools are operatively connected to a source of power that provides the necessary rotating speed and torque. Typical sources of power for such power tools include air motors that are connected to a pneumatic source and electric motors that are connected to an electrical source, which may include batteries and/or a power cord that connects to an outlet or other source of electricity. Although rotary power tools work generally well for their intended purposes, which include forming cut-outs and the like, they are not usually utilized to cut composition roof shingles, linoleum flooring, carpet, drywall and similar work materials to a desired length and/or shape. As a result, rotary power tools are not utilized with cutting blades to perform cutting operations on such work materials.

None of the prior art devices provide much of an improvement over the results achieved with the standard composition knife with regard to being able to easily and quickly cut composition shingles, particularly the thicker composition shingles. With regard to other work materials such as linoleum flooring, carpet and drywall, the various tools that are available or been offered as improvements to the standard cutting knife used for the specific material, are generally not as commonly utilized or accepted as the standard knife itself. What is needed, therefore, is an improved cutting tool for cutting composition shingles, linoleum flooring, carpet, drywall and other work materials. The preferred cutting tool should be configured to more easily and quickly cut through composition roofing shingles, even the more modern thicker shingles, and other work materials with minimum effort exerted by the user. Preferably, the improved cutting tool would be configured to be a hand-held tool that utilizes cutting blades of the type that are currently available for cutting such work materials. The preferred cutting tool should be configured by combining a cutting tool adapter with a hand-held rotary power tool that is pneumatically or electrically powered. Preferably, the cutting tool adapter can be utilized with a variety of differently configured rotary power tools to support a cutting blade in a manner that allows the user of such a tool to beneficially cut a variety of work materials.

### SUMMARY OF THE INVENTION

The cutting tool adapter for rotary power tools of the present invention solves the problems and provides the benefits identified above. That is to say, the present invention discloses an adapter that removably attaches to a rotary power tool, such as a drill, Dremel, Rotozip or die grinder, to provide a cutting tool which easily and quickly cuts through composition shingles, linoleum flooring, carpet, drywall and other work materials and, as a result, requires much less effort by the user than the commonly utilized cutting knife and the other prior art cutting tools. In the preferred embodiment, the cutting tool adapter of the present invention attaches to a pneumatically or electrically powered rotary power tool, including the cord and cordless types, to vibrate a cutting blade so as to facilitate cutting through composition shingles and other work materials with a minimum amount of physical cutting effort by the user. The preferred cutting tool adapter of the present invention has an adapter body sized and configured to removably attach to an end of the rotary power tool and utilizes replaceable standard straight edge, hook or notched blades selected for the work material. In the preferred embodiment, operation of the rotary power tool rotates a shaft, which has one or more eccentric weights connected thereto, inside a chamber of the adapter to impart vibration to a cutting blade attached to the adapter so as to improve the cutting effect of the blade.

In one general aspect of the present invention, the cutting tool attachment for vibrating tools comprises a tool housing that includes a handle section and a head section, a cutting blade that is attached to the tool housing, the cutting blade having one or more cutting edges, and a vibrating mechanism that is associated with the tool housing for vibrating the cutting blade so as to more easily and quickly cut composition shingles to their desired size and configuration. In the preferred embodiment, the cutting blade has at least two cutting edges and it is pivotally attached to a head body in the head section so as to allow the user to selectively place the cutting blade in position for cutting in a rearward/pulling direction or a forward/pushing direction. Preferably, the head section is separate from but attached to one end of an elongated handle that comprises the handle section so as to reduce the amount of vibration where the tool is held by the user when cutting composition shingles. If desired, a dampening member can be disposed between the head and handle sections to further reduce vibration at the handle. In alternative embodiments, the head and handle sections are integral and the vibrating mechanism is disposed in the integral component or the vibrating mechanism is disposed in the separate handle section. The vibrating mechanism can comprise a pneumatically powered motor with a pneumatic connector provided to connect to a pneumatic line. An air regulating control valve can be utilized to allow the user to regulate the flow of air to the motor so as to control the amount of vibration. In an alternative embodiment, the vibrating mechanism comprises an electric motor that is either powered by batteries disposed in the handle section or by a cord that connects to an outlet or other source of electrical power. In the preferred configuration, the cutting tool is configured to be a relatively small, hand-held device that can be quickly deployed to cut composition shingles when needed or desired. Standard hook blades or bow-tie blades can be utilized with the cutting tool. In use, the cutting blade is locked into its desired position, the vibrating mechanism is activated, the user places the cutting edge against the composition shingles at the place where he or she desires to cut it and then the user directs the cutting blade along the cutting path. The vibration of the cutting blade will make it much easier and faster for the user to cut the shingles.

In the cutting tool adapter embodiment of the present invention, the cutting tool adapter easily and quickly converts a rotary power tool to a linear cutting tool similar to that described above that can be used to beneficially cut composition shingles, linoleum flooring, carpet, drywall and like work materials. In a preferred embodiment of this invention, the rotary power tool is a standard drill, Dremel, RotoZip, die grinder or the like that has a rotating assembly at a first end of the tool and a source of power, such as a pneumatic or electric (including cord or cordless) power source, that is operatively connected to the rotating assembly to rotate the rotating assembly. The preferred cutting tool adapter has an adapter body that defines a chamber therein and which removably attaches to the first end of the rotary power tool and a vibrating mechanism that is disposed inside the chamber that connects to the rotary element to impart a vibration force to a cutting blade that is attached to a blade support extending downward from the adapter body. The cutting blade, having one or more cutting edges thereon, can be of the type that is specially configured for cutting composition shingles, linoleum flooring, carpet, drywall or a variety of other work materials. In the preferred embodiment, the second end of the adapter body removably attaches to the rotary power tool and the cutting blade is removably attached to the blade support, which is disposed generally below the chamber of the adapter body to position the cutting blade below the chamber and the vibrating mechanism which rotates within the chamber. In a preferred embodiment, the second end of the adapter body has a threaded portion configured to threadably engage a threaded section of the rotary power tool to removably attach the adapter to the rotary power tool.

The preferred vibrating mechanism comprises an elongated shaft and one or more eccentric weights attached to the shaft that rotate with the shaft as it rotates about its longitudinal axis in response to the rotating movement of the rotating assembly. In a preferred embodiment, the shaft has a first end disposed at the second end of the adapter body that attaches to the rotating assembly so as to rotate therewith and a second end that extends into the chamber toward the first end of the adapter body to allow the shaft to rotate about its longitudinal axis inside the chamber. The eccentric weights on the shaft are positioned so as to be disposed in the chamber above the blade support to rotate with the shaft and vibrate the cutting blade. The vibration of the cutting blade provides a cutting tool that is much more effective and efficient and requires much less effort by the user to cut the work material, particularly thick work materials. Typically, the rotating assembly will comprise a chuck and the first end of the shaft is secured thereto in order to rotate the shaft with the rotation of the rotating assembly. Some rotating assemblies will have a collar that secures the shaft to the chuck. If desired, one or more bearings can be connected to the shaft and rotatably disposed inside the chamber of the adapter body to support the shaft while it rotates in the chamber. In one embodiment, at least one of the bearings is disposed in a bearing chamber located at the first or distal end of the adapter body.

Accordingly, the primary objective of the present invention is to provide a cutting tool adapter for rotary power tools that is useful for cutting a wide variety of different work materials, including composition shingles, linoleum flooring, carpet, drywall and the like, that provides the advantages discussed above and overcomes the disadvantages and limitations associated with presently available material cutting tools.

It is also an important objective of the present invention to provide a cutting tool adapter for cutting composition shingles and other work materials that removably attaches to a rotary power tool to vibrate the cutting blade so as to more easily and quickly cut the work material with less cutting effort exerted by the user.

It is also an important objective of the present invention to provide a cutting tool adapter for rotary power tools that is adaptable to being configured for a wide variety of different sizes and configurations of such tools, including those rotary power tools that are pneumatically or electrically powered, to vibrate a cutting blade as it slices through composition shingles or other work materials so as to substantially reduce the amount of physical force required by the user.

It is also an important objective of the present invention to provide a cutting tool adapter that removably attaches to a rotary power tool, such as a standard drill, Dremel, RotoZip or die grinder, so the user may easily switch between using the rotary power tool for its intended or normal use, such as drilling or like rotary work, and to vibrate a cutting blade to cut shingles, flooring, carpet, drywall or other work materials in a generally linear manner.

It is also an objective of the present invention to provide a cutting tool adapter for rotary power tools that utilizes commonly available cutting blades, including those that are specially configured for specific work materials such as composition shingles, carpet and drywall.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is side view of a cutting tool for cutting composition shingles configured according to a preferred cutting tool embodiment of the present invention showing the head portion attached to the handle, the cutting blade configured for pulling the tool through the composition shingles and the tool configured for attachment to a supply of compressed air;

FIG. 2 is a side view of the cutting tool for composition shingles of FIG. 1 showing use of batteries to supply power to the vibrating mechanism and the cutting blade configured for pushing the tool through the composition shingles;

FIG. 3 is a side view of the cutting tool of FIG. 2 showing use of an electric cord to supply power to the vibrating mechanism;

FIG. 4 is a side view of an alternative embodiment of the cutting tool for composition shingles of the present invention showing the vibrating mechanism incorporated into a vibrating housing so as to vibrate the notched cutting blade;

FIG. 5 is a side view of the head section showing the components of the vibrating mechanism disposed therein;

FIG. 6 is a side view of a cutting tool adapter configured according to a preferred attachment embodiment shown attached to a Dremel-type rotary power tool so as to define a cutting tool and in use cutting a work material such as a composition shingle;

FIG. 7 is a top view of the cutting tool adapter and rotary power tool of FIG. 6;

FIG. 8 is an end view of the cutting tool adapter and rotary power tool of FIGS. 6 and 7;

FIG. 9 is a top view of the cutting tool adapter of FIG. 8 shown with the cutting blade removed therefrom;

FIG. 10 is a bottom view of the cutting tool adapter of FIG. 8 shown with the cutting blade removed therefrom;

FIG. 11 is an exploded side view of the cutting tool adapter of the embodiment of FIGS. 6 through 8 shown in spaced apart relation from the first end of the rotary power tool;

FIG. 12 is a side view of the cutting tool adapter of the embodiment of FIGS. 6 through 8 shown attached to the first end of the rotary power tool and with the adapter body in cross-section, taken through lines 12-12 of FIG. 9, to better illustrate the components and the positioning of the vibrating mechanism therein;

FIG. 13 is a cross-sectional side view of the adapter body of the cutting tool adapter of FIGS. 6 through 8 taken through lines 12-12 of FIG. 9;

FIG. 14 is a side view of the vibrating mechanism utilized with the cutting tool adapter of FIG. 12;

FIG. 15 is side view of an alternative configuration of the cutting tool adapter of the present invention shown attached to a RotoZip rotary power tool;

FIG. 16 is a bottom view of the cutting tool adapter of FIG. 15 shown without the cutting blade;

FIG. 17 is a side view of an alternative configuration of the cutting tool adapter of the present invention shown attached to a pneumatically powered die grinder;

FIG. 18 is a side view of the prior art pneumatically powered die grinder utilized in FIG. 17;

FIG. 19 is an end view of the first end of the prior art pneumatically powered die grinder utilized in FIG. 17;

FIG. 20 is a top view of the prior art pneumatically powered die grinder utilized in FIG. 17 with the end cap thereof removed;

FIG. 21 is a side view of the cutting tool adapter of FIG. 17 shown with the cutting blade removed therefrom;

FIG. 22 is a top view of the cutting tool adapter of FIG. 17 shown with the cutting blade removed therefrom;

FIG. 23 is a side view of the cutting tool adapter of the embodiment of FIG. 21 shown attached to the first end of the rotary power tool of FIG. 17 and with the adapter body in cross-section, taken through lines 23-23 of FIG. 22, to better illustrate the components and the positioning of the vibrating mechanism therein;

FIG. 24 is a cross-sectional side view of the adapter body of the cutting tool adapter of FIGS. 17 and 21 taken through lines 23-23 of FIG. 22;

FIG. 25 is a side perspective view of the vibrating mechanism utilized with the cutting tool adapter of FIGS. 23 and 24;

FIG. 26 is an end view of the vibrating mechanism of FIG. 25; and

FIG. 27 is a side view of an alternative configuration of the cutting tool adapter of the present invention shown attached to an electric drill.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed description and drawings are merely illustrative of the preferred embodiments and, as such, represent several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are directed to certain types of hand-held, rotary power tools, those skilled in the art will readily understand that this is merely for purposes of simplifying the present disclosure and that the present invention is not so limited, as the present invention is equally applicable for use with a drill and other similarly configured power tools.

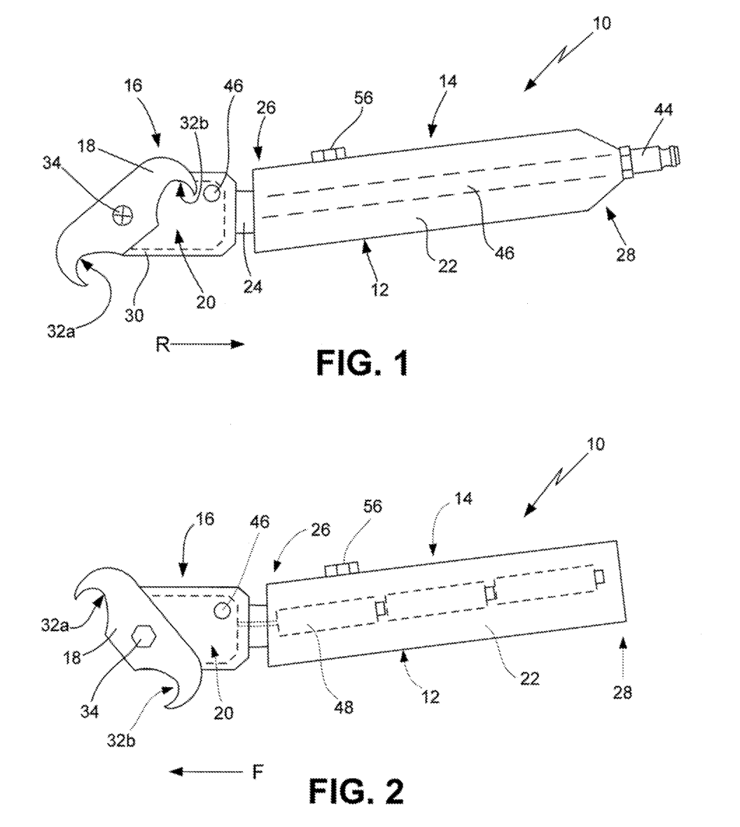

A cutting tool manufactured out of the components and configured pursuant to one embodiment of the present invention is shown generally as 10 in FIGS. 1 through 4. In this embodiment, cutting tool 10 generally comprises a tool housing 12 having a handle section 14 and a head section 16, a cutting blade 18 and a vibrating mechanism 20 associated with the tool housing 12 for imparting vibration to cutting blade 18. In the preferred configuration of this embodiment, shown in FIGS. 1 through 3, handle section 14 and head section 16 are separate components that are joined together with the vibrating mechanism 20 disposed inside head section 16. In an alternative embodiment, shown in FIG. 4, handle section 14 and head section 16 are integral such that tool housing 12 is a unitary housing member with vibrating mechanism 20 disposed inside tool housing 12. The primary benefit of having handle section 14 separate from, but connected to, head section 16 is to reduce the vibration at elongated handle 22, which is the part of cutting tool 10 held by the user during use. In other embodiments, vibrating mechanism 20 can be disposed inside handle section 14 or attached externally to the outer surface of tool housing 12 (i.e., disposed inside a separate housing component). As explained in more detail below, vibrating mechanism 20 is configured to impart vibration to cutting blade 18 so tool 10 will cut composite shingles faster and easier than with prior art shingle cutting tools. Because the vibration of cutting blade 18 must be of sufficient intensity to assist cutting blade 18 cutting through the asphalt composite shingles, the user of cutting tool 10 will likely feel some of that vibration at the point where his or her hand holds onto cutting tool 10 at handle 22. Separating the head section 16, which in a preferred configuration encloses or houses the vibrating mechanism 20, will reduce the vibrations felt by the user. If desired, a vibration damping member 24 can be utilized to interconnect handle section 14 and head section 16 so as to further reduce the vibration felt by the user as he holds onto handle 22.

In the preferred configuration of this embodiment, handle section 14 comprises a hand grippable, tubular handle 22 having a first end 26 and a second end 28 and head section 16 comprises a head body 30 configured with an internal chamber in which is positioned vibrating mechanism 20. As set forth in the embodiments shown in the figures, head body 30 of head section 16 connects to or is integral with the first end 26 of handle 22. For ease of use, it is preferred that the overall length of cutting tool 10 be approximately six to seven inches and that handle 22 have a generally circular cross-section with a diameter of approximately one to three inches. As will be readily apparent to those skilled in the art, however, this embodiment of the present invention is not so limited, as the cutting tool 10 can be of any size suitable for use to cut composite shingles and the cross-section of handle 22 can be square, rectangle, hexagon, octagon or various other shapes. Handle 22 and head body 30 can be manufactured from a variety of materials, including metal, plastics and suitable composites. The materials for cutting tool 10 should be selected with the knowledge that cutting tool 10 will be used by those in the roofing industry under somewhat difficult situations. As such, the materials for handle 22 and head body 30 should be as lightweight as possible yet durable, corrosion resistant and generally impact resistant. In addition, because the user of cutting tool 10 will usually be cutting roofing materials laying on a flat surface, it is preferred that the centerline of handle 22 be somewhat at an angle relative to a plane extending along the bottom of head body 30 (as shown in the figures), below which cutting blade 18 extends, for ease of cutting purposes. In a preferred configuration, this angle is approximately 20 to 30 degrees. With this configuration, the user will not have to tilt cutting tool 10 during use to cut composite shingles.

The cutting blade 18 of the embodiment shown in the figures is attached to the outer surface of head body 30 such that the cutting edge 32 of cutting blade 18 extends outwardly of head body 30 to cut the asphalt shingles. Although cutting blade 18 can have a single cutting edge 32, in the preferred embodiment, cutting blade 18 has two or more cutting edges, shown as 32a and 32b in FIGS. 1 and 32a, 32b, 32c and 32d in FIG. 4 (collectively the cutting edges are referred to as cutting edge 32) for rearward cutting (i.e., pulling cutting tool 10 toward the user in the direction indicated as “R” on FIG. 1) or forward cutting (i.e., pushing the cutting tool 10 away from the user in the direction indicated as “F” on FIG. 2). As known to those skilled in the art, some people in the roofing industry prefer to pull the composition knife or other prior art cutting device through the composition shingles and others prefer to push the knife to cut the shingles at the desired location. In the configuration shown in FIG. 1, with cutting edge 32a shown extending downward from head body 30, the cutting tool 10 is ready for rearward R or pulling use, whereas in the configuration shown in FIG. 2 the cutting edge 32b is for forward F or pushing use. In a preferred embodiment, shown in FIGS. 1 through 3, cutting edges 32a and 32b will be of the hooked type, such as the carbon hook utility blades from Irwin Industrial Tool Company (i.e., item number 2087100) or the large hook blade from Stanley Tools (i.e., product number 11-983). In an alternative embodiment, shown in FIG. 4, cutting blade 18 is of the notched, bow-tie type available from American Safety Razor Co. (i.e., model number MM0970-34). Although shown with the hook blade and the bow-tie blade in FIGS. 1 through 4, the invention is not so limited. As will be readily apparent to those skilled in the art, a straight edge blade or other configurations of cutting blade 18 can also be utilized with cutting tool 10 of the present invention to cut asphalt shingles. Preferably, which ever configuration of cutting blade 18 is utilized, the blade will preferably be of sufficient size to extend below head section 16 far enough to cut even the modern thicker composite shingles.

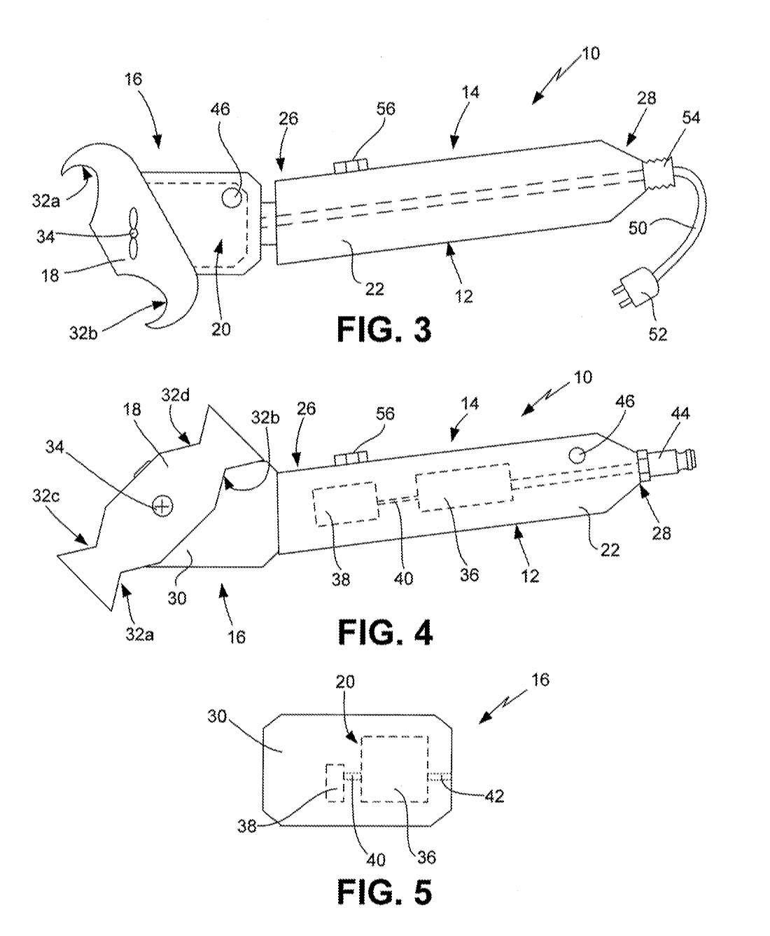

To facilitate the user selectively switching between the rearward R use of FIG. 1 and the forward F use of FIG. 2, it is preferred that cutting blade 18 be pivotally attached to head body 30 of head section 16. Preferably, cutting blade 18 is pivotally attached to head body 30 in a manner that allows the user to easily and quickly configure the cutting tool 10 for either rearward R or forward F cutting of the asphalt composite shingles. The head section 16 includes a connecting mechanism, shown as 34 in the figures, that connects the cutting blade 18 to head body 30 and securely holds it in position during use. Although the force required to be exerted by the user when utilizing cutting tool 10 will be somewhat less than with prior art devices, the connecting mechanism 34 must be able to effectively lock cutting blade 18 in the desired cutting position so as to prevent undesirable pivoting of cutting blade 18 during use. In the embodiments shown in FIGS. 1 and 2, the connecting mechanism is a phillips style screw. The embodiment shown in FIG. 2 utilizes a standard hexagon nut and the embodiment of FIG. 3 utilizes a wing nut. The connecting mechanisms shown in these figures are merely intended to be exemplary of the different types of connecting means 34 that can be utilized for cutting tool 10 of the present invention. Numerous other types of connecting mechanisms 34, including some which may be more or less difficult and quick to operate than those shown, can also be utilized to allow the user to selectively pivot cutting blade 18.

In the various figures of the preferred embodiments of the cutting tool 10 of the present invention, cutting blade 18 is removably attached to the outside of head body 30 by one or more connecting mechanisms 34. Alternatively, though not shown in the figures, those skilled in the art will readily understand and appreciate that head body 30 can be configured such that cutting blade 18 is received in or through head body 30, such as in a channel, cavity or other location on head body 30, and be clamped or otherwise be securable in a non-moving manner. As with current box cutter types of composition knives, cutting tool 10 can be configured with cutting blade 18 being retractable such that it is received inside head body 30 when not in use. Although not shown, those skilled in the art will readily understand that the head section 16 can include an internal sliding mechanism having an external thumb or finger guide to direct the cutting blade 18 between the exposed, locked cutting position and the retracted, stored position. The key requirement with regard to the placement of cutting blade 18 on or in head body 30 is that the cutting edge 32 of cutting blade extend outward of head body 30 during use to cut the shingles and that cutting blade 18 be in or be suitable for secure, non-moving attachment to head body 30 during use so as to effectively cut the asphalt composition shingles and reduce the likelihood of injury to the user of cutting tool 10. Another key requirement for cutting blade 18 is that it be relatively easily removed from cutting tool 18 for replacement when it becomes worn or damaged during use. In the preferred configuration, as set forth above, cutting blade 18 should be able to pivot relative to head body 30 so as to allow the user to pivot or rotate the cutting edges 34.

The key improvement of cutting tool 10 is the use of vibrating mechanism 20 to assist with the cutting of asphalt composition shingles by cutting blade 18. The present inventor has been in the roofing business for many years and has seen significant changes with regard to the composition shingles used for roofing. As set forth above, the materials utilized for composition shingles have changed and the shingles have gotten much thicker and, therefore, much harder to cut with the standard composition knife. Due to the difficulty of cutting the modern, thicker composition shingles, the inventor attempted to find an easier way to cut the composition shingles, but had little success until he developed the cutting tool 10 with the vibrating mechanism 20. Identifying the benefit to cutting composite shingles by the addition of vibration to the cutting blade 18 significantly improved the ease and speed at which the shingles are cut, a result not expected by the inventor or by those skilled in the art of hand tools for roofing materials. The improvement in cutting shingles from the cutting tool 10 of the present invention applies to straight cuts and non-straight (i.e., curved or circular) cuts that are necessary to lay the shingles around roof projections and curved roof lines. The amount of vibration necessary to obtain the improvement of the present invention does not have to be significant. The inventor has found that the vibration imparted by other vibrating tools is sufficient to vibrate the cutting blade 18 and improve the cutting of asphalt composition shingles.

As stated above, in the preferred embodiment of cutting tool 10 the vibrating mechanism 20 is disposed inside head body 30 of head section 16. Alternatively, as shown in FIG. 4, vibrating mechanism 20 can be incorporated into handle 22 of handle section 14. The use of vibration mechanism 20 to impart a vibration to a tool component is well known in the art and is commonly utilized in conjunction with other tools, most notably portable vibrating sanders, and with other non-construction devices, including muscle relaxing vibrators and back scratchers. Numerous configurations for vibrating mechanism 20 are suitable for use with cutting tool 10 of the present invention. As best shown in FIG. 5, such vibrating mechanisms 20 generally comprise a motor 36 that turns an eccentric weight 38 and a shaft 40 that interconnects the motor 36 and eccentric weight 38. As set forth in more detail below, a tubular channel or wire 42 connects to a source of power for motor 36. As the motor 36 rotates shaft 40 with eccentric weight 38 attached thereto, the imbalanced nature of rotating eccentric weight 38 will impart a vibratory force to cutting tool 10, preferably primarily just the head section 16, to vibrate cutting blade 18 and obtain the ease of cutting for the present invention.

Although various types of motors 36 may be suitable for use with cutting tool 10, the preferred motors 36 are of the pneumatic or electrical type due to the present use of such power sources in the roofing industry. Because many roofers currently utilize pneumatic nail driving tools to apply composition shingles, it may be preferred to utilize a pneumatic motor 36 for cutting tool 10, as shown in FIGS. 1 and 4. In this manner, the compressed air supply line can connect to a Y connector at the user to divide the air line out to the currently used pneumatic nailer and to connect to a pneumatic connector 44 on the cutting tool 10 of the present invention. As shown in FIG. 1, pneumatic connector 44 can be located at the second end 28 of handle 22 with a pneumatic line or channel 46 inside handle 44 to connect to tube 42 and motor 36 so as to deliver compressed air to a rotor having air actuated blades or vanes. In the embodiment shown in FIG. 4, with motor 36 disposed inside the integral tool housing 12, the extra pneumatic line 46 may not be necessary. In either embodiment, it may be preferred to provide cutting tool 10 with an air regulating control mechanism 46 operatively connected to motor 36 so as to regulate the flow of compressed air to motor 36 in order to reduce or increase the vibration at cutting blade 18 so the user can have a smoother handling tool 10 or be able to cut thicker composition shingles. Control mechanism 46 is shown on head body 30 in FIG. 1 and on handle 22 in FIG. 4 so as to be more closely associated with motor 36.

In an alternative embodiment, motor 10 can be electric and powered by one or more rechargeable batteries 48, shown in FIG. 2, or a power cord 50, shown in FIG. 3, electrically connected to electric motor 36. Preferably, batteries 48 are of the rechargeable type so that the user can have a cordless cutting tool 10 that merely has to be recharged during non-use, as is common for many other tools in the roofing industry, as well as the construction industry in general. If batteries 48 are utilized for cutting tool 10, then it is preferred that the second end 28 of handle 22 be configured to be opened, either by unscrewing a cap at the end 28 or removing a door-like member so as to allow the user to remove batteries 48 from handle 22 for replacement as may be needed. If the electric motor 36 has power supplied through power cord 50, having a plug 52 at its distal end for plugging into a source of electricity (i.e., wall outlet or compressor), then batteries 48 become optional or even unnecessary. Preferably, the second end 28 of handle 22 in the embodiment of FIG. 3 is provided with a cord support member 54, commonly utilized with corded power tools, to prevent flexing of the power cord 50 resulting in damage to tool 10 or power cord 50.

In either the pneumatic or electric motor 36 embodiments, cutting tool 10 is preferably provided with an on/off switch 56 operatively connected to motor 36 to allow the user more control over the operation of cutting tool 10. The on/off switch 56 can be of the type that stays on when switch 56 is moved to the on position or it can be of the type that requires the user to maintain sufficient force against the switch 56 to keep it in the on position, so as to immediately shut off motor 36 when the force is released as a safety consideration, or a switch 56 can be a combination of the two. In the preferred embodiment, on/off switch 56 is located on handle 22 so that the user's thumb may easily reach it during use of cutting tool 10. Also in the preferred embodiment, handle 22 is covered with a rubber or like material to provide improved gripping, both from a comfort and a safety standpoint, of cutting tool 10 during use. Although handle 22 may be provided in a generally smooth configuration as shown in the figures, it may be preferred to provide a coarser surface and/or finger grips for even more improved gripping of cutting tool 10.

In use, the user selects whether he or she desires to have cutting blade 18 pivoted to the rearward R cutting direction or to the forward F cutting direction, as shown in FIGS. 1 and 2, respectively, and then connects cutting tool 10 to a source of pneumatic or electric power, as may be necessary. If provided, the cutting blade 18 is moved from its stored, retracted position to its operating, extended position. With cutting tool 10 connected to power and cutting blade 18 pivoted to the desired position, and locked into place on head section 16, the user then moves the on/off switch 56 to the “on” position so as to activate the pneumatic or electric motor 36 of the preferred embodiment of cutting tool 10 of the present invention. As a result of motor 36 rotating eccentric weight 38 via shaft 40 of vibrating mechanism 20, a vibration force will be imparted to cutting blade 28. The user then moves cutting blade 18 across the position on the composition shingle where he or she desires to make the cut with the cutting edge 32 against the composition shingle. The vibration of cutting blade 18 from vibration mechanism 20 will significantly reduce the amount of force that must be asserted by the user against the composition shingle, thereby easing and speeding up the cutting process. Once the user has cut the desired section of composition shingle, he or she moves the on/off switch to the “off” position and removes the cutting blade 18 from the composition shingle. If so provided, the user retracts the cutting blade into the head section 16 so as to prevent unintentional contact with cutting edge 32.

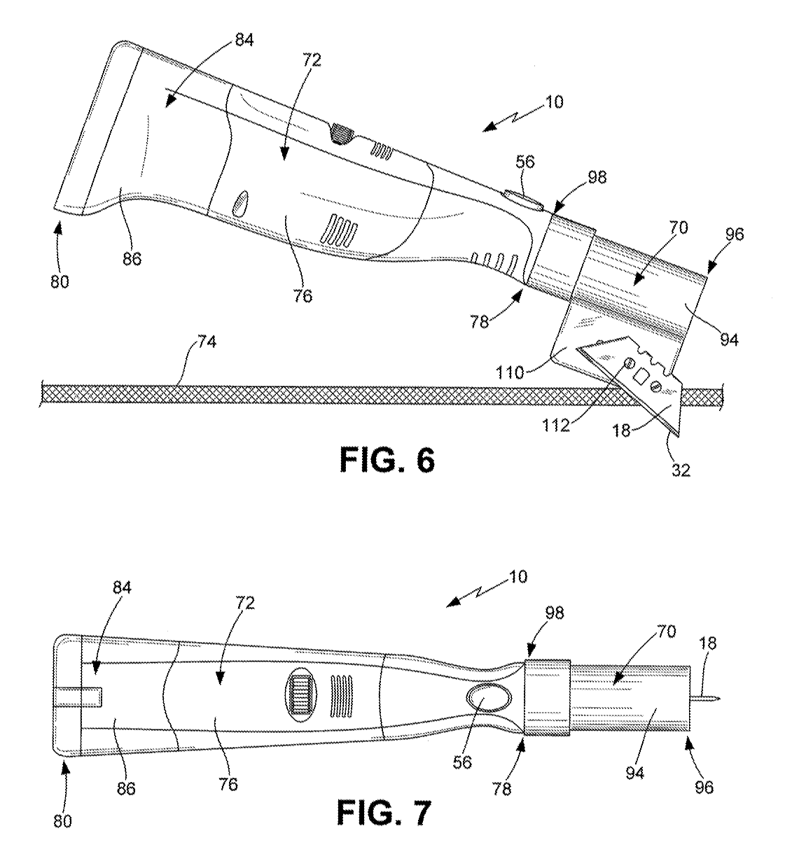

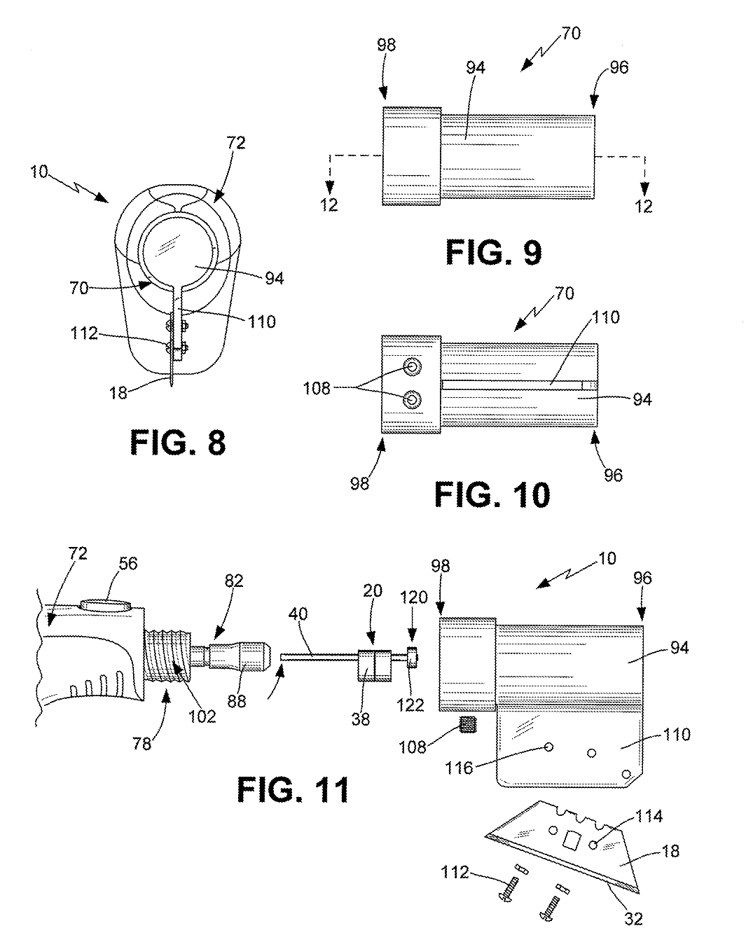

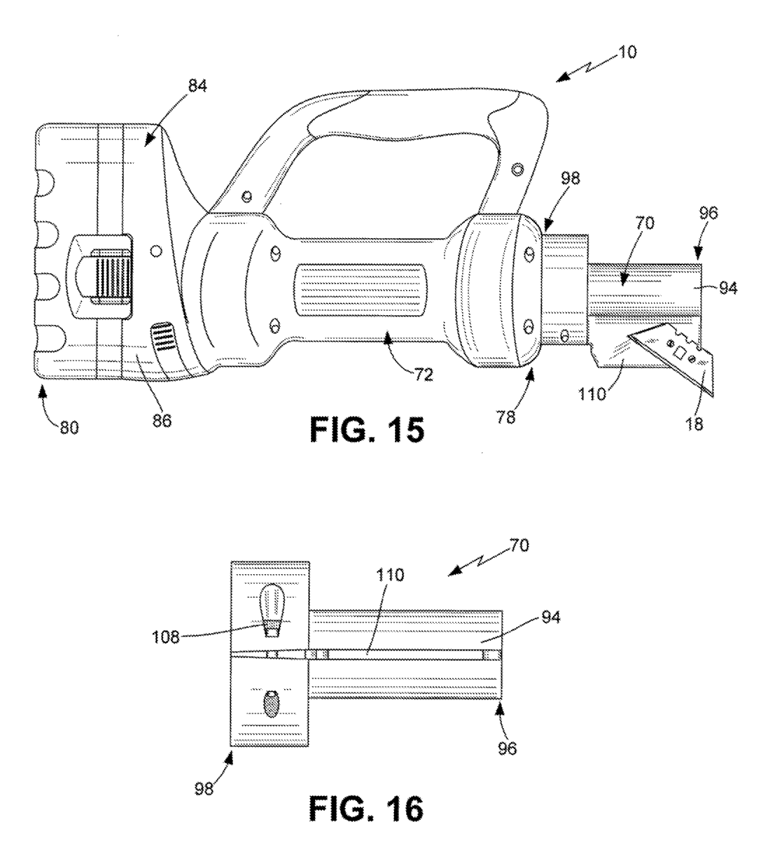

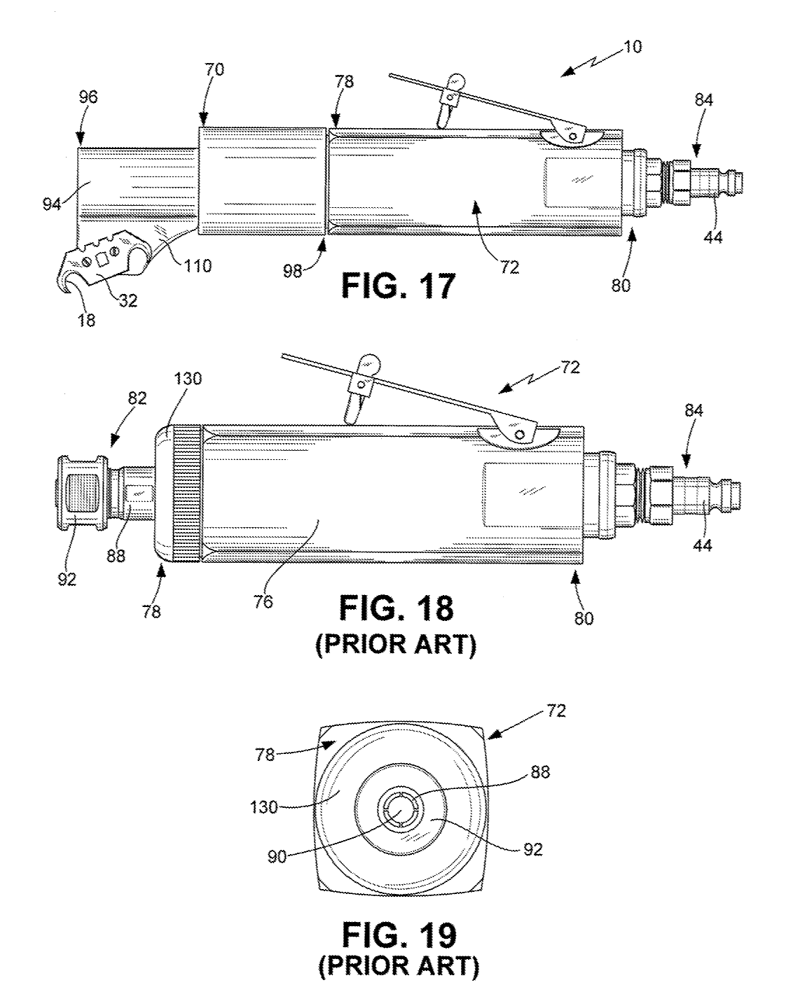

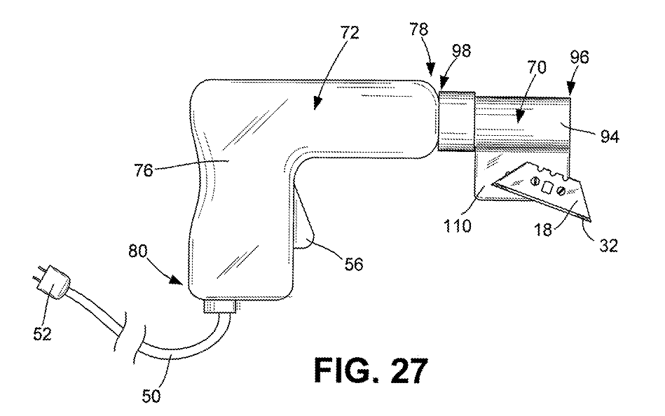

In the preferred embodiment of the present invention, cutting tool 10 is defined by attaching a cutting tool adapter, shown as 70 in FIGS. 6-8, 15 and 17, to a rotary power tool 72 to cut a work material 74 (shown in FIG. 6), such as composition shingles, linoleum flooring, carpet or drywall. Examples of rotary power tools 72 which adapter 70 can attach include tools such as the Dremel shown in the FIGS. 6 and 7, the RotoZip of FIG. 15, the pneumatic die grinder of FIGS. 17-20 and the drill of FIG. 27. As will be readily understood by persons skilled in the art, the various rotary power tools 72 and work materials 74 shown, described and/or referred to herein are included for exemplary purposes only and are not intended to limit the scope of the present invention. Cutting tool adapter 70 can attach to rotary power tool 72 in various different ways to achieve the objectives of the present invention. In one embodiment, adapter 70 can fixedly attach to the rotary power tool 72 or be manufactured so as to be integral with rotary power tool 72 to form cutting tool 10. In a preferred embodiment, cutting tool adapter 70 is removably attached to the rotary power tool 72 so the user may easily and quickly switch between utilizing the rotary power tool 72 for its original purpose (i.e., drilling, rotary cutting, sanding, sharpening, polishing and the like) or as a cutting tool 10 by attaching cutting tool adapter 70 thereto. As set forth in more detail below, in the preferred embodiment the adapter 70 of the present invention threadably attaches to one end of the rotary power tool 72. As will be readily apparent to those skilled in the art, various other means of removably connecting the adapter 70 to the rotary power tool 72 can be utilized depending on the configuration of the rotary power tool 72, including by using such devices as screws, bolts or other connectors, brackets, clamping mechanism or the like. Any such removable connecting means should securely attach the cutting tool adapter 70 to rotary power tool 72 so the cutting tool 10 formed thereby is able to easily, quickly and safely cut through the work material 74.

As will be readily understood by those skilled in the art, rotary power tool 72 comprises a rotary power tool body 76 that encloses a motor (not shown) that is sized and configured to perform the tasks normally associated with rotary power tool 72. In a preferred embodiment of the present invention, the rotary power tool will have a motor that is able to produce approximately 0.5 to 2.0 horsepower, with a 1.0 hp or 2 hp motor being generally preferred. The rotary power tool 72 has a first end 78 and a second end 80 with a rotating assembly 82, shown in FIGS. 11, 12, 18, 20 and 23, generally at the first end 78 and a source of power 84 at or near the second end 80, with the motor being disposed inside the rotary power tool body 76 between the first 78 and second 80 ends thereof. The source of power 84 may be a rechargeable battery pack 86, as shown in FIGS. 6, 7 and 15, a pneumatic connector 44, as shown in FIGS. 17, 18 and 20, configured to connect to a supply of pressurized air or a power cord 50, shown in FIG. 27, configured to connect a supply of AC power, such as an outlet or the like, as suitable to provide power for the motor of rotary power tool 72. Depending on the type of rotary power tool 72 other sources of power 84 may be utilized to power the rotary power tool 72 and, therefore, cutting tool 10. Although the foregoing specific sources of power 84 are described and shown herein, this is merely for exemplary purposes as the present invention is not so limited. The source of power 84 provides power to the motor, whether electric powered, air powered or powered by other means, which is operatively connected to the rotating assembly 82 to rotate one more components thereof. The normal use of such rotary power tools 72, which is well known to those skilled in the art, is to rotate a drill bit or other object to allow the object to directly perform a work operation, such as drilling, rotary cutting, sanding, sharpening, polishing and the like, on a work material 74. Unlike the present invention, which in a preferred embodiment utilizes rotating assembly 82 to rotate a vibrating mechanism 20 that vibrates a cutting blade 18 (as set forth in more detail below), the standard use of such rotary power tools 72 does not normally benefit from any vibration of or vibratory forces imparted to the drill bit or other device operated by the rotary power tool 72. In fact, generally it is the objective of the rotary power tool 72 to substantially eliminate or at least minimize the vibratory effect imparted on any drill bit or other device connected to the rotating assembly 82.

The rotating assembly 82 of the typical rotary power tool 72 comprises a chuck 88, such as shown in FIGS. 11 and 12, that in standard use of rotary power tool 72 is configured to removably receive the shaft of the drill bit or other device that is utilized with the rotary power tool 72 and rotatably secure such device to the first end 78 of rotary power tool 72. As shown in the prior art tool of FIG. 19, chuck 88 defines an aperture 90 that is opened to receive the shaft of the device and closed to secure the device to the rotary power tool 72. The configuration and use of chucks 88 are well known to persons skilled in the art. As shown in FIGS. 18, 19, 20 and 23, some rotating assemblies 82 utilize a collet or other collar 92 to open and close the aperture 90 around the shaft of the device to be rotated by the rotary power tool 72. As will be set forth in more detail below, the cutting tool adapter 70 of the present invention also utilizes the chuck 88, aperture 90 and collar 92 (if applicable) to secure the vibrating mechanism 20 to the rotary power tool 72 to produce a vibratory force that is imparted to the cutting blade 18 so the cutting edges 32 thereof may more easily and quickly cut through the work material 74, as shown in FIG. 6. Although certain types of rotating assemblies 82 are shown in the figures, those skilled in the art will readily appreciate that the rotary power tools 72 which may be utilized with the adapter 70 of the present invention may have a wide variety of different configurations. In the preferred embodiment of the present invention, the rotating assembly 82 of rotary power tool 72 is configured to receive one end of an elongated shaft, such as those similar to what are used for drill bits and other devices, and removably secure the shaft to the rotary power tool 72 so the shaft rotates with the rotating assembly 82.

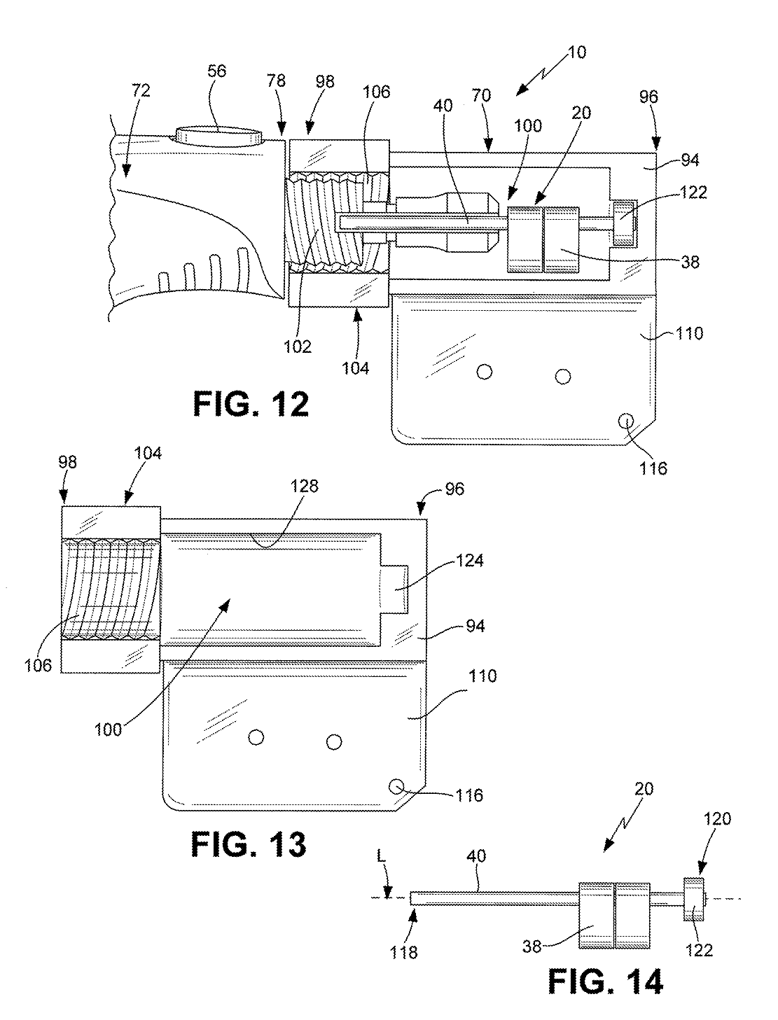

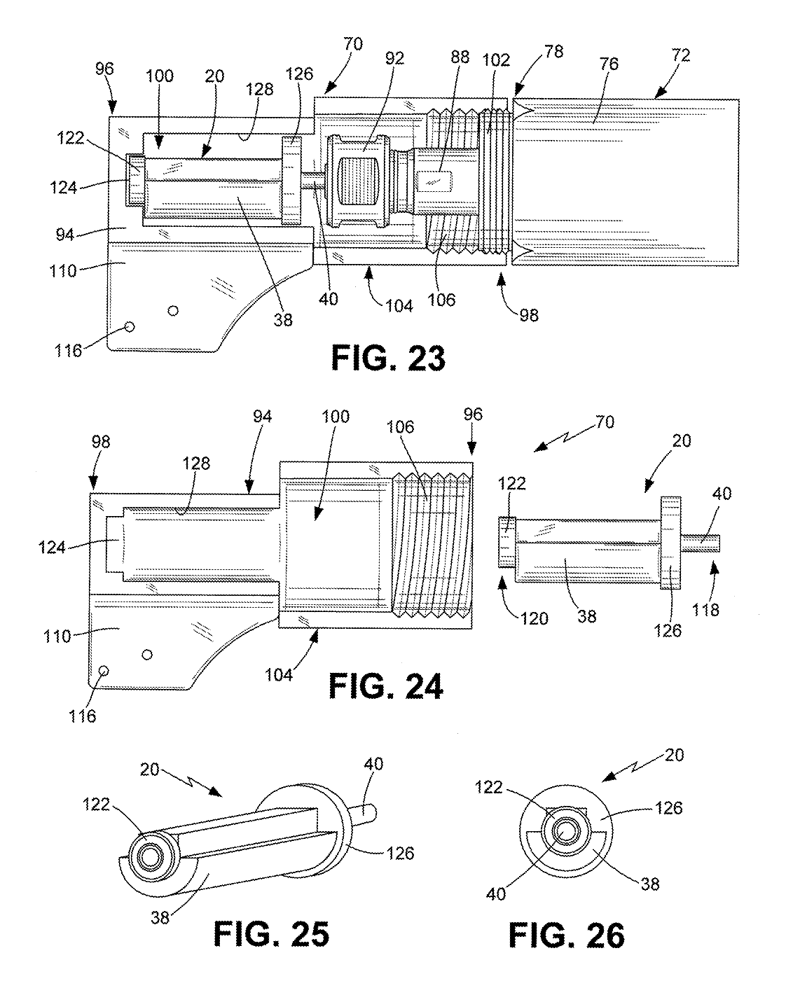

The cutting tool adapter 70 of the present invention has an adapter body 94 with a first end 96 and a second end 98. The adapter body 94 defines a chamber 100 inside adapter body 94 that is sized and configured to enclose, or at least substantially enclose, the vibrating mechanism 20 at the first end 78 of the rotary power tool 72. In the preferred embodiment, the first end 96 of adapter body 94 is closed and the second end 98 of adapter body 94 is open and configured to engage the first end 78 of the rotary power tool 72, typically via a threaded section 102 that is located at or near the first end 78 of rotary power tool 72, as shown in FIGS. 11, 12, 20 and 23. In a preferred embodiment, the cutting tool adapter 70 extends distally from the first end 78 of rotary power tool 72 when it is attached to rotary power tool for use to cut work material 74, as shown in the figures. To facilitate attachment of the cutting tool adapter 70 to rotary power tool 72, the adapter 70 has engaging section 104 at the second end 98 of adapter body 94 that is configured to securely, but preferably removably, attach the adapter 70 to rotary power tool 72. In the preferred embodiment, the engaging section 104 comprises an internally threaded portion 106, as best shown in FIGS. 13 and 24. The threaded portion 106 of adapter 70 is configured to threadably engage the threaded section 102 of the rotary power tool 72, as shown in FIGS. 12 and 23. The threaded portion 106 of adapter 70 should be configured such that it threadably engages the threaded section 102 in a manner that positions the adapter 70 with the cutting blade 18 disposed in a generally downwardly projecting position, as shown in FIGS. 6 through 8. Preferably, the threaded portion 60 and the threaded section 102 are cooperatively configured such that the user can easily spin or otherwise rotate the adapter 70 onto the rotary power tool 72 without utilizing any tools, connectors or requiring any undue amount of force, yet securely attach adapter 70 to rotary power tool 72. If desired, however, the engaging section 104 can be provided with wrench flats or the like to facilitate tightening adapter 70 onto rotary power tool 72 or utilize one or more connectors, such as the set screws 108 shown in FIGS. 10, 11 and 16 to provide a clamp-like force that helps hold the adapter 70 in place on rotary power tool 72.

As will be readily apparent to those skilled in the art, a variety of mechanisms can be utilized to securely attach adapter 70 to rotary power tool 72. For instance, the second end 98 of the adapter 70 and the first end of the rotary power tool 72 can be cooperatively configured such that they lockingly engage each other by pushing the adapter 70 over the end of the rotary power tool 72 or pushing the rotary power tool 72 over the end of the adapter 70. Tools that lockingly engage a removable portion are well known in the art. Likewise, the adapter 70 and rotary power tool 72 can be cooperatively configured such that one component clamps onto a portion of the other component, utilizing one or more connectors or other devices to obtain the desired clamping action. Tools that use clamping systems to attach a removable component to the main portion of the tool are also well known in the art. If desired, adapter 70 can be made integral with rotary power tool 72 or otherwise be configured so as to be non-removable, such that the rotary power tool 72 is only utilized as a cutting tool 10.

As stated above and shown in the figures, cutting blade 18 attaches to adapter 70 so as to dispose the cutting edges 32 of the cutting blade 18 in a position advantageous to cut through the work material 74. Generally, the use of cutting tool 10 formed by adding the adapter 70 to the rotary power tool 72 is benefited by having the cutting blade 18 disposed in a downwardly projecting manner below the rotary power tool 72, as best shown in FIGS. 7, 8, 15, 17 and 27. It is also preferred that the cutting blade 18 be removably attached to adapter 70 so the user can replace the cutting blade 18 as it becomes worn or swap out one type of cutting blade 18 for another type that is better suited for cutting the specific type of work material to be cut (as discussed above).

In the preferred embodiment of the present invention, the adapter 70 has a blade support 110 attached to or integral with the adapter body 94 and positioned thereon such that it projects downward from adapter body 94 when adapter 70 is securely attached to rotary power tool 72, as shown in FIGS. 6, 12, 15, 17, 23 and 27. Preferably, adapter body 94 and the downwardly projecting blade support 110 are manufactured as an integral unit out of a relatively lightweight, strong, durable, corrosion-resistant material, such aluminum or the like, so that it can withstand the various forces and conditions adapter 70 will be exposed to while in use and/or storage. The blade support 110 is configured to support, preferably removably, the cutting blade 18 in a manner that allows the cutting tool 10 to be utilized to effectively and efficiently cut the work material 74. Although cutting blade 18 can be made integral with the blade support 110, it is preferred that cutting blade 18 be removably attached to the blade support 110. In the preferred embodiment shown in the figures, the cutting blade 18 is removably attached to the blade support 110 utilizing one or more screws, bolts or other connecting elements 112, as best shown in FIGS. 6, 8 and 11. To facilitate the removable attachment of the cutting blade 18 to the blade support 110, in the preferred embodiment cutting blade 18 has one or more apertures 114 that are configured and positioned on cutting blade 18 to cooperate with one or more apertures 116 on the blade support 110, as best shown in FIG. 11. Preferably, the apertures 114 on cutting blade 18 and the apertures 116 on blade support 110 are cooperatively positioned to disposes the cutting blade 18 at an angle relative to the bottom edge of the blade support 110 such that the cutting edge 32 thereof which is used to cut the work material 74 extends at a downward angle relative to the rotary power tool 72 for ease and comfort of use. The apertures 114/116 are also sized to receive the connecting elements 112 utilized to attach the cutting blade 18 to the blade support 110. Alternatively, various other devices can be utilized to removably attach the cutting blade 18 to the blade support 110 that extends downwardly from the adapter body 94.

Although cutting tool 10 could be utilized with adapter 70 attached to rotary power tool 72 without any mechanism to vibrate the cutting blade 18, effectively turning the rotary power tool 72 into a larger-sized utility knife, the inventor has found it much more beneficial to incorporate a vibrating mechanism 20 that imparts a vibratory force to the cutting blade 18 through blade support 110 and adapter body 94. The vibration supplied as a result of the rotating movement of rotating assembly 82 on the vibrating mechanism 20 significantly improves the cutting efficiency and effectiveness of the cutting blade 18. By imparting a vibration to the cutting blade 18, the inventor has found that the cutting edges 32 of cutting blade 18 move much easier through the work material 74 relative to a tool that has a cutting blade 18 that is not subject to a vibratory force. This vibration significantly reduces the amount of effort required by the user to cut the work material 74, which is very noticeable on the thicker work materials, thereby reducing the user's fatigue and the likelihood of injury to the user. The inventor has also found that placement of the vibrating mechanism 20 above the blade support 110, having the cutting blade 18 attached thereto, substantially improves the effectiveness of transmitting the vibratory force to the cutting blade 18. As such, only a relatively small amount of vibratory force is needed to provided the desired vibration of the cutting blade 18. As shown in the figures, the present invention positions the vibrating mechanism 20 above the blade support 110 and the cutting blade 18 attached thereto.

In a preferred embodiment, the vibrating mechanism 20 comprises an elongated shaft 40 having one or more eccentric weights 38 mounted onto or integral with the shaft 40 between the first end 118 and the second end 120 of shaft 40, as best shown in FIGS. 11, 14 and 24. The first end 118 of the shaft 40 is rotatably supported by the rotating assembly 82, such as chuck 88, and the second end 120 of shaft 40 extends into the chamber 100 defined by the adapter body 94, as best shown in FIGS. 12 and 23 to rotate about its longitudinal axis L, shown in FIG. 14. Preferably, the eccentric weights 38 are positioned on shaft 40 such they are disposed above where the cutting blade 18 is attached to the blade support 110. Rotation of the eccentric weights 38 by shaft 40, as a result of it being rotatably supported by or connected to the rotating assembly 82, produces a vibratory force that is transmitted to the cutting blade 18 to improve the efficiency and effectiveness of the desired cutting action. As set forth above, the inventor has found that positioning eccentric weights 38 above blade support 110 and cutting blade 18 more effectively transmits the vibration force caused by the rotating eccentric weights 38 to the cutting blade 18.

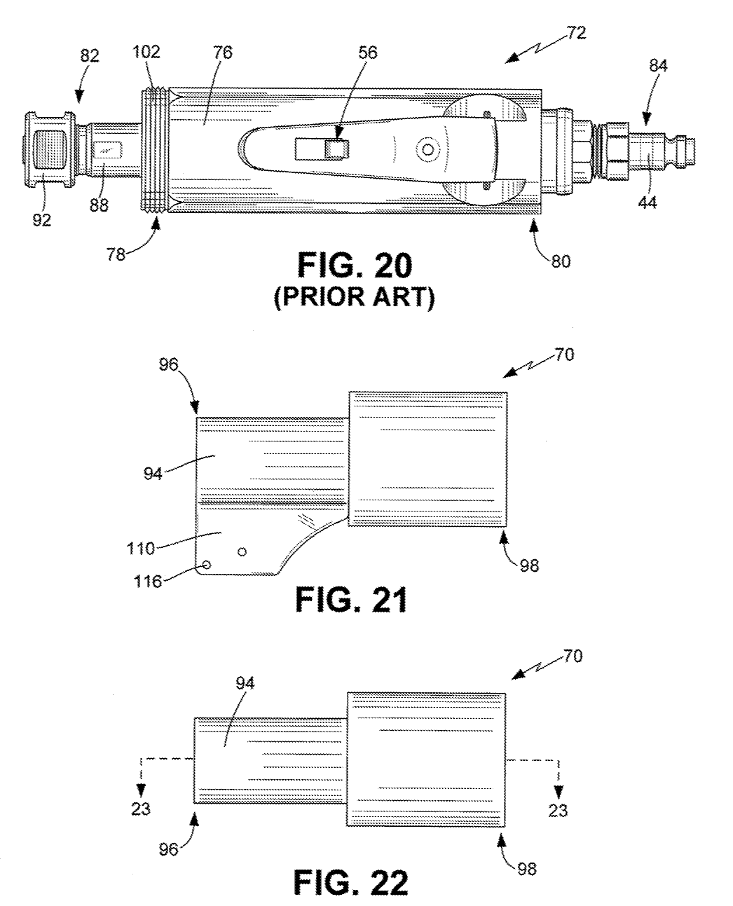

In one embodiment, the first end 118 of the shaft 40 is rotatably supported in a cantilever fashion inside the chamber 100, with the second end 120 of shaft 40 extending into and being unsupported inside the chamber 100. Depending on the configuration of the rotating assembly 82 supporting vibrating mechanism 20 in the cantilever fashion is sufficient to obtain the benefits of the present invention. In the preferred embodiment, however, the second end 120 of shaft 40 is rotatably supported inside chamber 100, as shown in FIG. 12. In this embodiment, the vibrating mechanism 20 comprises a first or end bearing 122 mounted on or attached to shaft 40 at or near the second end 120 thereof. The first bearing 122 is configured to supportedly rotate with shaft 40 inside a bearing chamber 124 of the main chamber 100, as shown in FIGS. 12 and 13. The bearing chamber 124 is sized and configured to rotatably receive first bearing 122 such that the first bearing 122 can rotate with shaft 40 while supporting some of the weight of the vibrating mechanism 20 and to more effectively transmit the vibratory force to the blade support 110 and cutting blade 18. In another embodiment, the vibrating mechanism 20 also comprises a second bearing 126 positioned between the eccentric weights 38 and where the first end 118 of the shaft 40 attaches to the rotating assembly 82, as shown with regard to the embodiment of FIGS. 17 through 26. In this embodiment, the second bearing 126 rotatably engages the interior wall 128 of the chamber 100 inside adapter body 94, as best shown in FIG. 23. If desired, both the first bearing 122 and the second bearing 126 can rotate against the interior wall 128 of chamber 100 or the chamber 100 can be configured with a separate bearing chamber for the second bearing 126 (not shown, but it would be similar to bearing chamber 124). As well known to those skilled in the art, the inside surfaces of the bearing chamber 124 and interior wall 128 should be sufficiently polished to allow the bearings 122/126, as applicable, to smoothly rotate inside chamber 100.

As set forth above, the adapter 70 of the present invention can be utilized with a variety of rotary power tools 72, such as the Dremel shown in the FIGS. 6 and 7, the RotoZip of FIG. 15, the pneumatic die grinder of FIGS. 17-20 and the electrical (corded) drill of FIG. 27, to obtain a cutting tool 10 that more efficiently and effectively cuts the work material 74. For the Dremel and RotoZip rotary power tools 72, the open second end 98 of the adapter 70 can be threadably attached to the first end 78 of the rotary power tool 72 by providing the engaging section 104 of the adapter 70 with an appropriately configured threaded portion that threadably engages the threaded section 102 of the rotary power tool 72. In one embodiment, each of the adapters 70 for these tools 72 utilize the set screws 108 to securely attach the adapter to the rotary power tool 72. For use with the die grinder of FIGS. 17 through 26, the inventor has found it best to slightly, and easily, modify the rotary power tool 72 to attach adapter 70 thereto by removing the end cap 130, shown in FIGS. 18 and 19 illustrating the prior art pneumatic die grinder that is supplied with the die grinder rotary power tool 72.

The end cap 130 can be removed from rotary power tool 72 by unthreading it from the first end 78 of rotary power tool 72 and then sliding it over chuck 88, after first removing the collar 92 from rotating assembly 82. The collar 92 is replaced on chuck 88 without end cap 130 to expose the threaded section 102 of the rotary power tool 72, as shown in FIG. 20. The threaded portion 106 of engaging section 104 of adapter 70 is configured to threadably engage the threaded section 102 of the rotary power tool 72 to install the adapter 70 on the rotary power tool 72, as shown in FIG. 17. As described above, the threaded portion 106 should be configured to position the blade support 110 in a generally downwardly disposed direction from rotary power tool 72 to place the cutting blade 18 in the desired position to cut through the work material 74. In the preferred embodiment, the threaded portion 106 of adapter 70 is configured to tightly engage the threaded section 102 of the rotary power tool 72 such that no set screws or other connectors 108 are needed to securely attach adapter 70 to rotary power tool 72. Depending on the configuration of the electric drill rotary power tool 72 of FIG. 27, the user may need to utilize one or more connectors 108 or one or more other devices to securely attach the adapter 70 to the first end 78 of the rotary power tool 72.

The adapter 70 for use with a rotary power tool 72 will generally have to be configured for a particular type of rotary power tool 72 so the mechanism for connecting the adapter 70 to the rotary power tool 72, such as the thread pattern of the threaded portion 106, can be configured to securely attach adapter 70 to the rotary power tool 72 and position the blade support 110 and cutting blade 18 downward from the rotary power tool 72 when it is held by the user. The rotary power tool 72 with which the adapter 70 is utilized can be powered by batteries in a battery pack 86, electricity through power cord 50, pressurized air through pneumatic connector 44 or powered by other available power systems. Typically, the user will select the power system for rotary power tool 72 that is most convenient and/or suitable for the tasks he or she will perform. For instance, many roofers presently utilize pneumatic power tools, such as nailing guns and the like. As a result, for such users the pneumatically powered rotary power tool 72 may be the preferred type of tool. Other users may prefer other types of rotary power tools 72 or may utilize a more than one type of rotary power tool 72 for a particular job and/or task.

In use, the user attaches the adapter 70 to the selected rotary power tool 72 by utilizing the connecting mechanism suitable for the rotary power tool 72, which most often will be a threaded connection between the threaded portion 106 of the adapter 70 and the threaded section 102 of the rotary power tool 72. For many die grinders, the user will have to first remove the end cap 130 to expose the threaded section 102 before attaching the adapter 70 to the rotary power tool 72. If necessary, one or more connectors 108 are used to more securely connect the adapter 70 to the rotary power tool 72. With the adapter 70 securely attached to the rotary power tool 72, the user attaches the desired cutting blade 18 to the blade support 110, if not previously attached, by using one or more connecting elements 112 or other connecting devices as appropriate for the particular cutting blade 18 and adapter 70. Once the cutting blade 18 is securely attached, the user only has to operate the rotary power tool 72 in the manner in which it is normally operated, except for cutting instead of its standard use, in order to use the cutting tool 10 to cut through a work material 74. The rotation of the rotating assembly 82 rotates the vibrating mechanism 20 inside the chamber 100 of the adapter 70. The eccentric weight 38 on the shaft 40 that is connected to and rotated by the rotating assembly 82 will produce a vibration that is transmitted to the cutting blade 18 by the blade support 110. This vibration will improve the cutting operation of cutting edge 32 of cutting blade 18 by reducing the amount effort that must be exerted by the user in order to cut through work material 74, particularly thick materials such as 50 year composition shingles or the like. As such, the adapter 70 will make easier and faster for the user to cut work materials 74 using a cutting blade 18.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein and modifications in assembly, materials, size, shape, and use. For instance, there are numerous components described herein that can be replaced with equivalent functioning components to accomplish the objectives of the present invention and use of the present adapter with other rotary power tools and/or to cut other types of work materials is included herein.

What is claimed is:

1. A cutting tool adapter for use in combination with a rotary power tool having a rotating assembly to cut a work material, said cutting tool adapter comprising:
an adapter body having a first end and a second end, said adapter body defining a chamber inside said adapter body, said second end of said adapter body configured to be attached to said rotary power tool;
a blade support attached to or integral with said adapter body;
a cutting blade supported by said blade support, said cutting blade having one or more cutting edges selected to cut said work material; and
a vibrating mechanism disposed inside said chamber of said adapter body, said vibrating mechanism configured to be rotatably connected to said rotating assembly so as to rotate therewith inside said chamber and vibrate said cutting blade.

2. The cutting tool adapter according to claim 1, wherein said vibrating mechanism comprises an elongated shaft and one or more eccentric weights on said shaft, said eccentric weights configured to vibrate said cutting blade due to rotation of said shaft inside said chamber.

3. The cutting tool adapter according to claim 2, wherein said shaft has a first end at said second end of said adapter body configured to be rotatably attached to said rotating assembly and a second end extending into said chamber toward said first end of said adapter body to allow said shaft to rotate about a longitudinal axis of said shaft inside said chamber.

4. The cutting tool adapter according to claim 3, wherein said eccentric weights are disposed above said blade support.

5. The cutting tool adapter according to claim 2, wherein said rotating assembly comprises a chuck configured to secure said first end of said shaft to said rotary power tool.

6. The cutting tool adapter according to claim 5, wherein said rotating assembly further comprises a collar on said chuck to secure said first end of said shaft in said chuck.

7. The cutting tool adapter according to claim 1 further comprising means associated with said adapter body for rotatably supporting said shaft inside said adapter body.

8. The cutting tool adapter according to claim 7, wherein said supporting means comprises one or more bearings rotatably disposed inside said chamber.

9. The cutting tool adapter according to claim 7, wherein said supporting means comprises at least one bearing rotatably disposed inside a bearing chamber at a first end of said adapter body for rotatably supporting said second end of said shaft.

10. The cutting tool adapter according to claim 1, wherein said second end of said adapter body is configured to be removably attached to said rotary power tool.

11. The cutting tool adapter according to claim 10, wherein said second end of said adapter body comprises a threaded portion configured to threadably engage a threaded section of said rotary power tool.

12. A cutting tool adapter for use in combination with a rotary power tool having a rotating assembly to cut a work material, said cutting tool adapter comprising:
an adapter body having a first end and a second end, said adapter body defining a chamber inside said adapter body, said second end of said adapter body configured to be removably attached to said rotary power tool;
a blade support attached to or integral with said adapter body, said blade support disposed generally below said chamber of said adapter body;
a cutting blade removably attached to said blade support, said cutting blade having one or more cutting edges selected to cut said work material;
an elongated shaft having a first end at said second end of said adapter body configured to be attached to said rotating assembly so as to rotate therewith and a second end extending into said chamber toward said first end of said adapter body to allow said shaft to rotate about a longitudinal axis of said shaft inside said chamber; and
one or more eccentric weights on said shaft and positioned so as to be disposed in said chamber above said blade support, said eccentric weights configured to rotate with said shaft so as to vibrate said cutting blade.

13. The cutting tool adapter according to claim 12, wherein said rotating assembly comprises a chuck configured to secure said first end of said shaft to said rotary power tool.

14. The cutting tool adapter according to claim 13, wherein said rotating assembly further comprises a collar on said chuck to secure said first end of said shaft in said chuck.

15. The cutting tool adapter according to claim 12 further comprising one or more bearings rotatably disposed inside said chamber of said adapter body.

16. The cutting tool adapter according to claim 15, wherein at least one of said bearings is disposed in a bearing chamber at said first end of said adapter body.

17. The cutting tool adapter according to claim 12, wherein said second end of said adapter body comprises a threaded portion configured to threadably engage a threaded section of said rotary power tool.

18. A cutting tool, comprising:
a rotary power tool having a rotating assembly at a first end thereof;
an adapter body having a first end extending outwardly from said rotary power tool and a second end attached to said first end of said rotary power tool;
a chamber inside said adapter body;
a blade support attached to or integral with said adapter body, said blade support disposed generally below said chamber;
a cutting blade removably attached to said blade support, said cutting blade having one or more cutting edges selected to cut said work material;
an elongated shaft having a first end attached to said rotating assembly so as to rotate said shaft therewith and a second end extending into said chamber toward said first end of said adapter body to allow said shaft to rotate about a longitudinal axis of said shaft inside said chamber; and
one or more eccentric weights on said shaft and disposed in said chamber above said blade support, said eccentric weights configured to rotate with said shaft so as to vibrate said cutting blade.

19. The cutting tool adapter according to claim 18 further comprising one or more bearings rotatably disposed inside said chamber of said adapter body.

20. The cutting tool adapter according to claim 18, wherein said second end of said adapter body is threadably attached to said rotary power tool so as to be removable therefrom.
